(19) United States
(12) Patent Application Publication
(10) Pub. No.: US 2019/0231085 A1
(43) Pub. Date: Aug. 1, 2019

(54) INFLATABLE PRODUCT AND TENSIONING BEAM THEREOF

(71) Applicant: Bestway (USA), Inc., Phoenix, AZ (US)

(72) Inventor: Shuiyong Huang, Shanghai (CN)

(73) Assignee: Bestway (USA), Inc., Phoenix, AZ (US)

(21) Appl. No.: 16/251,216

(22) Filed: Jan. 18, 2019

Related U.S. Application Data
(60) Provisional application No. 62/641,965, filed on Mar. 12, 2018.
(60) Provisional application No. 62/622,705, filed on Jan. 26, 2018.

(51) Int. Cl. A47C 27/08; B29C 65/04

(52) U.S. Cl. CPC A47C 27/087; B29L 2031/751; A47C 27/081; B29C 65/04

(57) ABSTRACT

An inflatable product including tensioning beams is described. The inflatable product may include a first wall, a second wall spaced apart from the first wall, and an air chamber defined by at least the first and second walls. The inflatable product includes a plurality of tensioning beams disposed in the air chamber and coupled to the first and second walls. Each of the tensioning beams can include a first sheet made of a first flexible material and having an outer perimeter and a second sheet made of a second flexible material and having an outer perimeter, the outer perimeter of the second sheet overlapping the outer perimeter of the first sheet. Each of the tensioning beams can include a first layer, a first and a second pair of coupling layers, and a sandwiching arrangement.

### CROSS-REFERENCE TO RELATED APPLICATIONS

This application claims priority to and the benefit of U.S. Provisional Application Patent Ser. No. 62/641,965, filed Mar. 12, 2018, and U.S. Provisional Application Patent Ser. No. 62/622,705, filed Jan. 26, 2018, the entire disclosures of which are hereby incorporated herein by reference.

### TECHNICAL FIELD

The present disclosure relates generally to an inflatable product and improved tensioning beams thereof.

### BACKGROUND

Inflatable products such as inflatable toys, inflatable beds, inflatable spas, inflatable sofas, and inflatable pools are well known in the art. Such products are typically light in weight, and easy to pack, store and carry.

Some inflatable products employ internal structures for forming the product into an intended, predetermined shape upon inflation. For example, airbeds may incorporate one or more coils or I-beams (i.e. tensioning structures or tensioning beams) within an inflatable chamber of the airbed. These tensioning beams are generally disposed at various locations within the inflatable chamber to shape the airbed as the inflatable chamber is pressurized. The tensioning beams can prevent the airbed from expanding evenly on all sides, similar to that of a balloon, and thus, facilitate the proper inflated shape of the airbed. More particularly, in order to maintain the desired shape of an airbed (e.g., rectangular), these tensioning beams may join, for example, upper and lower surfaces of the airbed to one another to restrict their separation during inflation.

In conventional inflatable products, such as the airbeds described above, the tensioning beams are typically made of plastic or polyvinyl chloride (PVC) sheets with a sufficient thickness to ensure that loads are properly distributed in the product. As such, conventional inflatable products utilizing plastic tensioning beams may meet their desired load requirements by varying the thicknesses of the tensioning beams. This may contribute to increased weight of the inflatable product. Similarly, an increase in the thickness and/or spatial density of the tensioning beams may also increase the compressed/folded volume of the deflated inflatable product.

Tensioning beams made of a solid PVC sheet generally are not strong enough to withstand high-pressure loads generated during inflation. Such inflatable products can be easily deformed once stretched beyond their elastic limit. This contorts the shape and weakens the strength of the inflatable product. Further, if the inflatable product is over-inflated, the tensioning beams can rip or tear along seams coupling the tensioning beams to, for example, the upper and lower surfaces of the inflatable product.

Accordingly, need exist for tensioning beams suited for inflatable products that are durable, yet lightweight and easy to manufacture.

### SUMMARY

This section provides a general summary of the present disclosure and is not a comprehensive disclosure of its full scope or all of its features, aspects, and objectives.

Disclosed herein are exemplary implementations of a tensioning beam for an inflatable product. One exemplary tensioning beam includes a first layer, a first and a second pair of coupling layers, and a sandwiching arrangement. A first portion of the first layer is sandwiched between the first pair of coupling layers and a second portion of the first layer is sandwiched between the second pair of coupling layers.

Also disclosed herein are exemplary implementations of an inflatable product including a first wall, a second wall spaced apart from the first wall, and an air chamber defined by at least the first and second walls. One exemplary inflatable product also includes a plurality of tensioning beams disposed in the air chamber and coupled to the first and second walls. Each of the tensioning beams includes a first sheet made of a first flexible material and having an outer perimeter. Each of the tensioning beams also includes a second sheet made of a second flexible material and having an outer perimeter, the outer perimeter of the second sheet overlapping the outer perimeter of the first sheet. The first sheet withstands a heavier load resulting from elongation than the second sheet.

Also disclosed herein are exemplary implementations of an inflatable product including a first wall, a second wall spaced apart from the first wall, and an air chamber defined by at least the first and second walls. One exemplary inflatable product also includes a plurality of tensioning beams disposed in the air chamber and coupled to the first and second walls. Each of the tensioning beams includes a first sheet made of a first flexible material and having an outer perimeter, the first sheet having a first surface, and a second surface. Each of the plurality of tensioning beams also includes a second sheet made of a second flexible material and having an outer perimeter, the outer perimeter of the second sheet overlapping the outer perimeter of the first sheet, and the second sheet being coupled to the first surface of the first sheet. Each of the tensioning beams also includes a third sheet made of thermoplastic material and having an outer perimeter, the outer perimeter of the third sheet overlapping the outer perimeter of the first sheet, and the third sheet being coupled to the second surface of the first sheet. The first sheet withstands a heavier load resulting from elongation than the second and third sheets.

### BRIEF DESCRIPTION OF THE DRAWINGS

The present disclosure is described by way of example, with reference to the accompanying drawings in which implementations of the disclosure are illustrated and, together with the descriptions below, serve to explain the principles of the disclosure. The accompanying figures are included to provide further understanding and are incorporated in and constitute a part of this specification. The accompanying figures disclose implementations that, together with the description, serve to explain principles of the disclosed implementations. It is emphasized that, according to common practice, the various features of the drawings are not to-scale. On the contrary, the dimensions of the various features are arbitrarily expanded or reduced for clarity.

FIG. 1 is a perspective view of an exemplary inflatable product in accordance with aspects of the present disclosure.

FIG. 2 is an exploded view of the inflatable product illustrated in FIG. 1 in accordance with aspects of the present disclosure.

FIG. 3 is a sectional view of the inflatable product illustrated in FIG. 1 in accordance with aspects of the present disclosure.

FIG. 4 is an exploded view of another exemplary inflatable product in accordance with aspects of the present disclosure.

FIG. 5 is a sectional view of the inflatable product illustrated in FIG. 4 in accordance with aspects of the present disclosure.

FIG. 6 is a partial perspective view of an exemplary tensioning beam assembled within an inflatable product in accordance with aspects of the present disclosure.

FIG. 7 is a sectional view of another exemplary tensioning beam assembled within an inflatable product in accordance with aspects of the present disclosure.

FIG. 8 is a sectional view of another exemplary tensioning beam assembled within an inflatable product in accordance with aspects of the present disclosure.

FIG. 9 illustrates a tensioning beam including an anti-elongation layer laminated between a pair of PVC layers in accordance with aspects of the present disclosure.

FIG. 9A illustrates a tensioning beam including an anti-elongation layer laminated with a layer, such as a PVC layer, in accordance with aspects of the present disclosure.

FIG. 9B illustrates the anti-elongation layer of the tensioning beams of FIGS. 9 and 9A in accordance with aspects of the present disclosure.

FIG. 10 illustrates a tensioning beam including a reinforcing layer and an anti-elongation layer in accordance with aspects of the present disclosure.

FIGS. 11, 11A, 11B, and 11C illustrate tensioning beams including an anti-elongation layer defining a plurality of holes in accordance with aspects of the present disclosure.

FIGS. 12A and 12B illustrate a tensioning beam including an anti-elongation layer defined by a plurality of strips arranged in an array in accordance with aspects of the present disclosure.

FIGS. 13 and 13A illustrate a tensioning beam including a coupling structure, and further illustrate first and second pairs of coupling layers in accordance with aspects of the present disclosure.

FIG. 14 illustrates a tensioning beam having a coupling structure including first and second folded coupling layers in accordance with aspects of the present disclosure.

FIGS. 15 and 15A illustrate a tensioning beam having a coupling structure including first and second coupling layers for coupling multiple edges or portions of an anti-elongation layer or a laminated multi-layer material, in accordance with aspects of the present disclosure.

FIGS. 16 and 16A illustrate a tensioning beam having a coupling structure including first and second coupling layers for laminating an anti-elongation layer or a laminated multi-layer material, in accordance with aspects of the present disclosure.

FIGS. 17 and 17A illustrate a tensioning beam having a multi-layer material defining a plurality of holes and a coupling structure including first and second folded coupling layers, in accordance with aspects of the present disclosure.

FIG. 18 illustrates a method of manufacturing a tensioning beam for an inflatable product in accordance with aspects of the present disclosure.

FIG. 19 illustrates a method of manufacturing a tensioning beam for an inflatable product in accordance with aspects of the present disclosure.

### DETAILED DESCRIPTION

In the following detailed description, numerous specific details are set forth to provide a full understanding of the present disclosure. It will be obvious, however, to one of ordinary skill in the art that the implementations of the present disclosure may be practiced without some of these specific details. In other instances, well-known structures and techniques have not been described in detail to avoid obscuring the disclosure. For purposes of clarity, some of the same reference numbers are used in the description and drawings to identify similar elements.

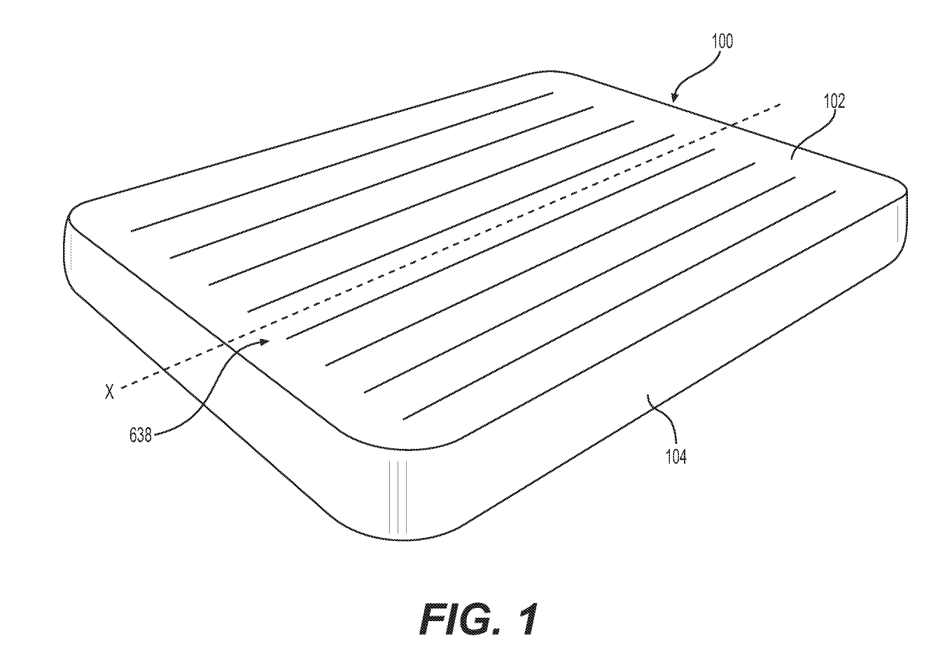

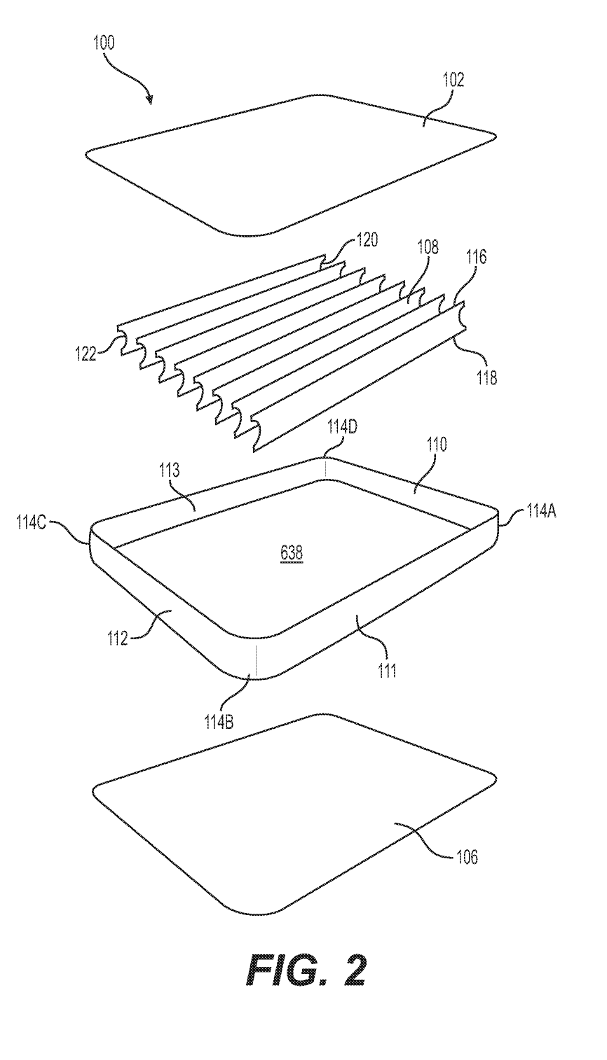

FIGS. 1 and 2 illustrate an inflatable product 100 in accordance with aspects of the present disclosure. The inflatable product 100 may be an inflatable mattress or airbed, an inflatable toy, an inflatable bed, an inflatable spa, an inflatable sofa, an inflatable pool, or any other desired inflatable product. The inflatable product 100 in FIG. 1 is an exemplary airbed having walls, such as a top wall 102, a lateral wall 104, a bottom wall 106, and a plurality of tensioning beams 108.

The top wall 102 can be positioned as an upper surface or an upper wall of the inflatable product 100. The bottom wall 106 can be positioned as a lower surface or a lower wall of the inflatable product 100. The top wall 102 and the bottom wall 106 may be similar shapes and sizes, such as a rectangular shape. In other embodiments, the top wall 102 and the bottom wall 106 are different shapes and/or sizes.

The lateral wall 104 can be positioned as a vertical surface or a vertical wall of the inflatable product 100. The inflatable product 100 can have more than one side of the lateral wall 104. For example, the lateral wall 104 may include a first side 110, a second side 111, a third side 112, and a fourth side 113. The lateral walls 104 can include two sides 110 and 112 positioned opposite each other and two sides 111 and 113 positioned opposite each other. The sides 110 and 112 can be shorter than the sides 111 and 113. The sides 110 and 112 can be substantially similar in size and shape. The sides 111 and 113 can be substantially similar in size and shape. Each side of the lateral wall 104 can connect at its end to another side of the lateral wall 104. The first side 110 can connect to the second side 111 at an end 114A, the second side 111 can connect to the third side 112 at an end 114B, the third side 112 can connect to the fourth side 113 at an end 114C, and the fourth side 113 can connect to the first side 110 at an end 114D, such that the lateral wall 104 forms a rectangle. The ends 114 can form a shape of a curve, a square, an angle, or any other desirable shape or configuration. The lateral wall 104 can be one continuous piece of material or multiple pieces of material attached together. The lateral wall 104 can form various shapes, such as a square, a rectangular, a circle, an oval, or any other desired shape.

The lateral wall 104 can be positioned between the top wall 102 and the bottom wall 106 about the perimeter of the top and bottom walls 102, 106. The lateral wall 104 can be substantially the same size about the outer perimeter. The lateral wall 104 can have substantially straight walls with curved edges, or any other desired shape or configuration. The top wall 102, the lateral wall 104 and the bottom wall 106 can be one continuous piece of material or multiple pieces of material attached together.

The inflatable product 100 can include one or more tensioning beam 108. The plurality of tensioning beams 108 illustrated in FIG. 2 can include numerous tensioning beams 108, each positioned parallel to each other, or in any other desirable configuration. The tensioning beam 108 can be positioned within the inflatable product 100. The tensioning beam 108 can be a similar length and width as the sides 111, 113, the sides 110, 112, the top wall 102, the bottom wall 106, or any other desired size. The plurality of tensioning beams 108 can be positioned in the inflatable product 100 such that each tensioning beam 108 is substantially parallel to the sides 111, 113, with each end of the tensioning beams 108 positioned adjacent and substantially perpendicular to the sides 110, 112. The tensioning beam 108 can include a first side 116, a second side 118, a first end 120, and a second end 122. When the tensioning beam 108 is positioned inside of the inflatable product 100, the first side 116 can be positioned adjacent the top wall 102, the second side 118 can be positioned adjacent the bottom wall 106, and the ends 120, 122 can be positioned adjacent side walls 110, 112, respectively. The tensioning beam 108 can be positioned in any other desirable configuration.

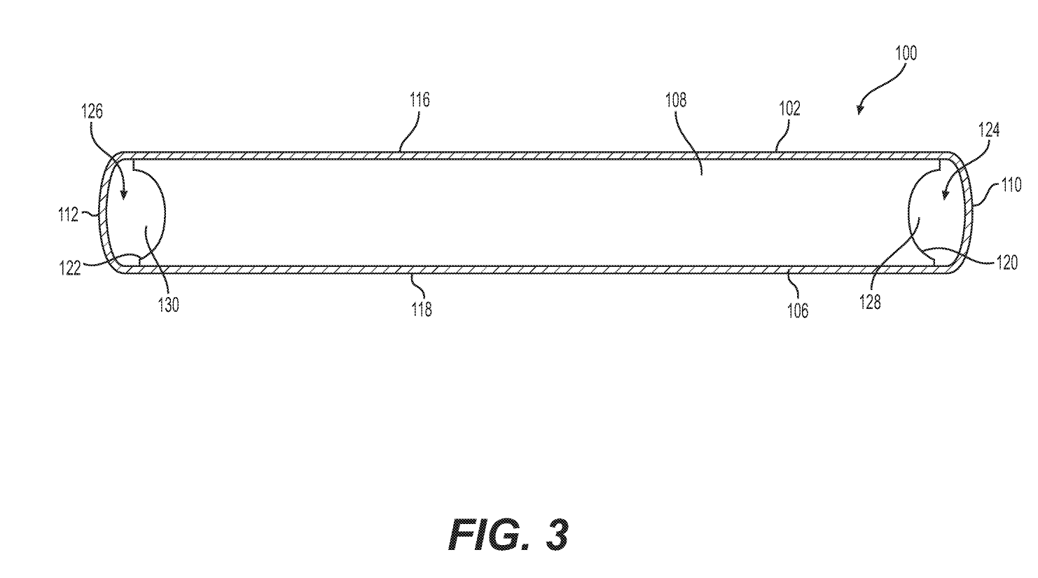

FIG. 3 illustrates a section of the inflatable product 100 taken along an X-axis shown in FIG. 1 in accordance with aspects of the present disclosure. The tensioning beam 108 can be positioned within the inflatable product 100. The first side 116 of the tensioning beam 108 can be positioned adjacent the top wall 102 and the second side 118 of the tensioning beam 108 can be positioned adjacent the bottom wall 106. The first end 120 of the tensioning beam 108 can be positioned adjacent a first side 110 of the lateral wall 104 and the second end 122 of the tensioning beam 108 can be positioned adjacent a third side 112 of the lateral wall 104. The tensioning beam 108 can be positioned in any other desirable configuration.

The first end 120 of the tensioning beam 108 can include a first recess 128. The second end 122 of the tensioning beam 108 can include a second recess 130. When the tensioning beam 108 is positioned inside of the inflatable product 100, a first gap 124 can form between the first end 120 and the first side 110 and a second gap 126 can form between the second end 122 and the third side 112. Air within the inflatable product 100 can reside in and/or flow through the gaps 124, 126. The recesses 128, 130 can cooperate with the lateral wall 104 to define the gaps 124, 126, respectively. The size and shape of the recesses 128, 130 create at least a portion of the size and shape of the gaps 124, 126. For example, if the first and second recesses 128, 130 of the tensioning beam 108 define the absence of more surface area from the tensioning beam 108 (i.e., have a deeper groove), the first and second gaps 124, 126 would consist of a larger area. The position and shape of the lateral wall 104 may change throughout different levels of inflation of the inflatable product 100. Thus, the amount of air and/or airflow may be affected by the level of inflation of the inflatable product 100. For example, if the inflatable product 100 is fully inflated, the lateral wall 104 may be taught and the amount of air residing and/or flowing through the gaps 124, 126 may be greater than if the inflatable product 100 is not fully inflated (i.e. the lateral wall 104 may adjust inwardly, making the gaps 124, 126 smaller). The inflatable product 100 can include additional and/or fewer components and configurations and is not limited to those illustrated in FIGS. 1-3.

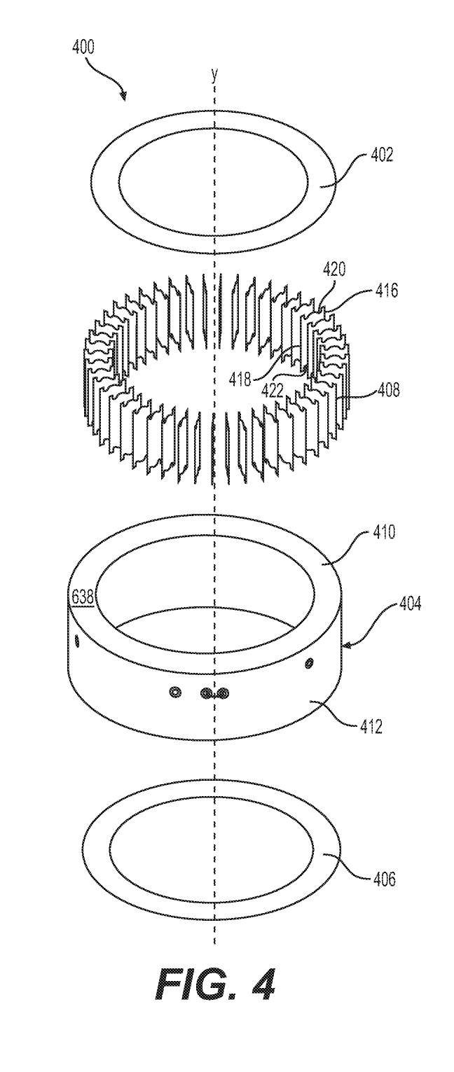

FIG. 4 illustrates an inflatable product 400 in accordance with aspects of the present disclosure. The inflatable product 400 may be an inflatable mattress or airbed, an inflatable toy, an inflatable bed, an inflatable spa, an inflatable sofa, an inflatable pool, or any other desired inflatable product. The inflatable product 400 is an exemplary inflatable spa having a top wall 402, a lateral wall 404, a bottom wall 406, and a plurality of tensioning beams 408.

The top wall 402 can be positioned as an upper surface or an upper wall of the inflatable product 400. The bottom wall 406 can be positioned as a lower surface or a lower wall of the inflatable product 400. The top wall 402 and the bottom wall 406 may be similar shapes and sizes, such as a ring shape. In other embodiments, the top wall 402 and the bottom wall 406 may be different shapes and/or sizes.

The inflatable product 400 can have more than one lateral wall 404. For example, the inflatable spa includes one lateral wall 404 having an internal wall 410 and an external wall 412. The lateral wall 404 can be positioned as a vertical surface or a vertical wall of the inflatable product 400. The lateral wall 404 can be positioned about the outer perimeter of the top and bottom walls 402, 406. For example, the lateral wall 404 can be cylindrically shaped such that the external wall 412 is positioned adjacent to the outer perimeters of the top and bottom walls 402, 406 and the internal wall 410 is positioned adjacent to the inner perimeters of the top and bottom walls 402, 406. In this configuration, the external wall 412 has a greater circumference than the internal wall 410, and the outer perimeters of the top and bottom walls 402, 406 have a greater circumference than the inner perimeters of the top and bottom walls 402, 406. The lateral wall 404 can be one continuous piece of material or multiple pieces of material attached together. The lateral wall(s) 404 can form various shapes, such as square, a rectangular, a circle (as shown by way of example here), an oval, or any other desired shape.

The inflatable product 400 can include one or more tensioning beam 408. The plurality of tensioning beams 408 illustrated in FIG. 4 can include numerous tensioning beams 408. The tensioning beams 408 can be arranged in a configuration to form a circle, or any other desired configuration. The plurality of tensioning beams 408 can be positioned within the inflatable product 400. For example, the tensioning beams 408 can be positioned between the internal and external walls 410, 412 and between the top and bottom walls 402, 406. The tensioning beams 408 can be a similar width as the lateral wall 404 (i.e., between the internal and external walls 410, 412) and a similar length as between the top and bottom walls 402, 406, or any other desired width or length. The plurality of tensioning beams 408 can be positioned in the inflatable product 400 such that each tensioning beam 408 is substantially perpendicular to the internal and external walls 410, 412 and substantially perpendicular to the top and bottom walls 402, 406. The tensioning beam 408 can include a first side 416, a second side 418, a first end 420, and a second end 422.

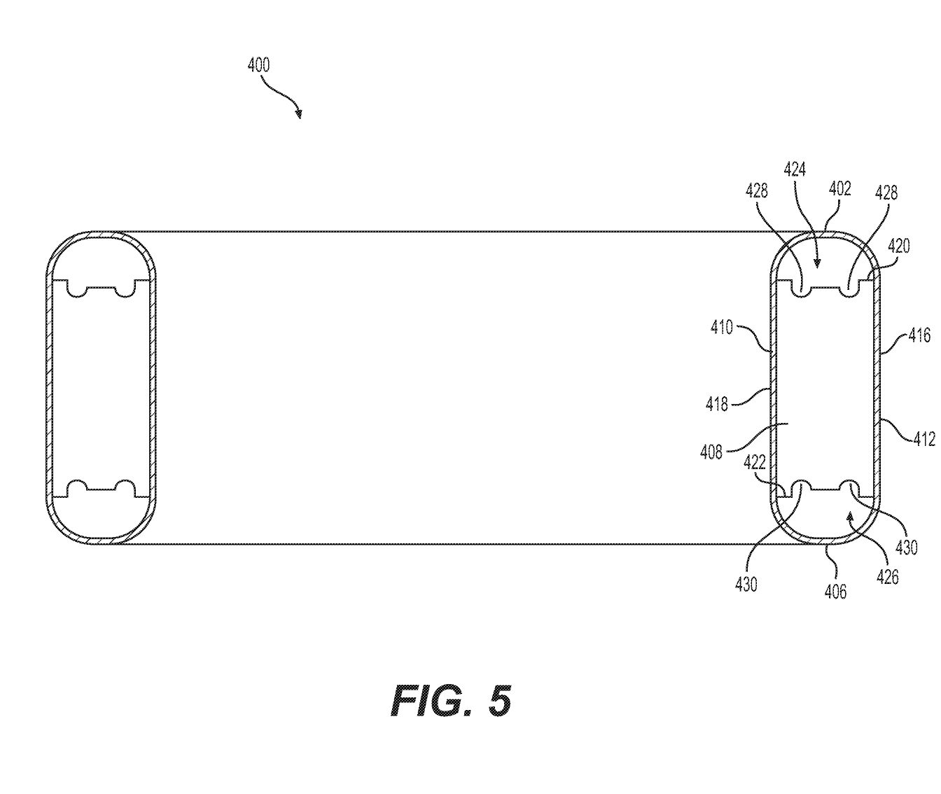

FIG. 5 illustrates a section of the inflatable product 400 taken along a Y-axis shown in FIG. 4 in accordance with aspects of the present disclosure. The tensioning beam 408 can be positioned within the inflatable product 400. The first side 416 can be positioned adjacent the external wall 412, the second side 418 can be positioned adjacent the internal wall 410, the first end 420 can be positioned adjacent the top wall 402, and the second end 422 can be positioned adjacent the bottom wall 406. The tensioning beam 408 can be positioned in any other desired configuration.

When the tensioning beam 408 is positioned inside of the inflatable product 400, a first gap 424 can form between the first end 420 and the top wall 402 and a second gap 426 can form between the second end 422 and the bottom wall 406. Gaps 424, 426 can be a gap, an aperture, a notch, or any other desired opening. The bottom wall 406 and the internal wall 410 can define a container for receiving water, liquid, or any other desired fluid. The top and bottom walls 402, 406, the internal and the external walls 410, 412, and the second sheet 634 can be made of flexible thermoplastic materials, such as PVC, polyurethane (PU), or any other desired material.

The first end 420 of the tensioning beam 408 can include one or more recesses 428. The second end 422 of the tensioning beam 408 can include one or more recesses 430. The recesses 428, 430 can cooperate with the top and bottom walls 402, 406 to define the gaps 424, 426. The inflatable product 400 can include additional and/or fewer components and configurations and is not limited to those illustrated in FIGS. 4 and 5.

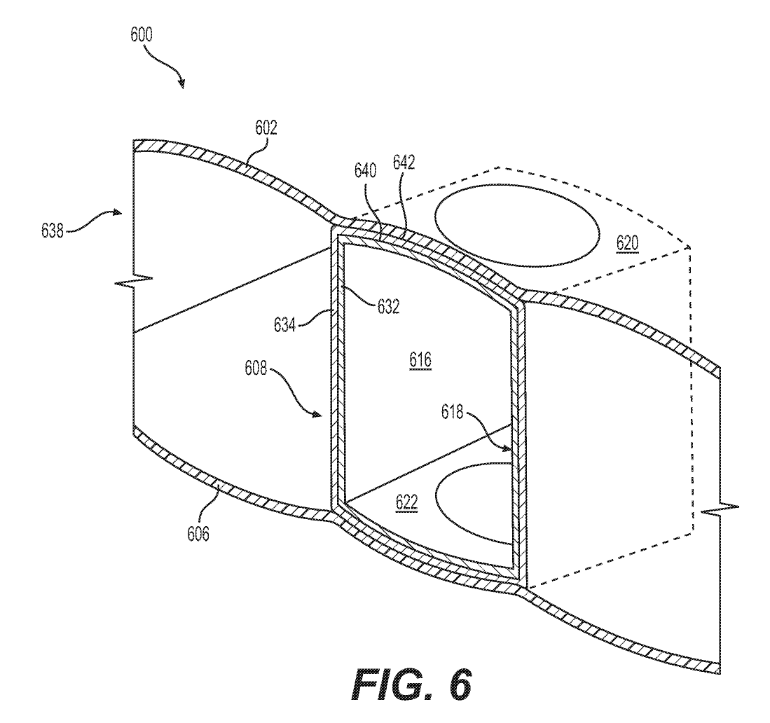

FIGS. 6-8 illustrate exemplary of implementations of the tensioning beam 608 in the inflatable products 600, 700, 800. These implementations can include additional and/or fewer components and configurations and is not limited to those illustrated in FIGS. 6-8.

In some exemplary implementations, the disclosure provides an inflatable product 600 (e.g., the inflatable product 100) including a first wall 602 (e.g., the top wall 102), a second wall 606 (e.g. the bottom wall 106) spaced apart from the first wall 602, an air chamber 638 defined by the first and second walls 602, 606, and a plurality of tensioning beams 608 disposed in the air chamber 638 and coupled to the first and second walls 602, 606. Each of the tensioning beams 608 can comprise a first sheet 632 made of a first flexible material and having an outer perimeter 640 and a second sheet 634 made of a second flexible material and having an outer perimeter 642. The second flexible material can be a flexible thermoplastic material or any other desired material. The outer perimeter 642 of the second sheet 634 can overlap the outer perimeter 640 of the first sheet 632. The first sheet 632 can withstand a heavier load at a certain elongation than the second sheet 634.

In some exemplary implementations, the first sheet 632 can include polyvinyl chloride (PVC) or any other desired material, while the second sheet 634 and/or the third sheet 636 can include PVC or any other desired material having different physical properties (such as hardness) from those of the first sheet 632. The PVC of the first sheet 632 can, in some exemplary implementations, withstand heavier loads at certain elongations, or stresses, than can the second sheet 634 and/or the third sheet 636. In other words, under the same elongating force, the PVC of the first sheet 632 can make the first sheet 632 more difficult to elongate than the second sheet 634 and/or the third sheet 636.

In some exemplary implementations, the first sheet 632 can be made of polyethylene terephthalate (PET) or any other desired material, while the second sheet 634 and/or the third sheet 636 can be made of PVC or any other desired material having different physical properties (such as hardness) from those of the first sheet 632. The PET of the first sheet 632 can, in some exemplary implementations, withstand heavier loads at certain elongations, or stresses, than can the second sheet 634 and/or the third sheet 636. In other words, under the same elongating force, the PET of the first sheet 632 can make the first sheet 632 more difficult to elongate than the second sheet 634 and/or the third sheet 636.

In some exemplary implementations, the tensioning beam 608 can include both a PVC sheet (which can be a thin film) and a PET sheet (which can be a thin film). After the inflatable product is changed (e.g., due to inflation, elongation, elasticity, deformation, and/or any other desirable change), the tensioning beams 608 due to a heavy load can be reduced at a certain elongation, elastic deformation, and/or strain degree of the PET and/or PVC. Further, the tensioning beams 608 can have stronger tear resistance due to the PVC sheet having a stronger tear resistance than the PET sheet.

As illustrated in FIGS. 6-8, the tensioning beams 608 can be coil shaped, “I” shaped, or any other desired shape. In some exemplary implementations, a first, second, and/or any additional layers of the tensioning beams 608 may be non-porous.

The improved tensioning beams 608 can overcome defects of deformation caused by elongation, where deformation of the tensioning beams 608 can result in adverse deformation of the inflatable product 600. Further, the improved tensioning beams 608 can improve the pressure resistance of the inflatable product 600, 700, 800.

Below are further exemplary, non-limiting features, methods, and structures that may be employed with any embodiment of the present invention.

One exemplary implementation can include the inflatable product 600. The inflatable product 600 can comprise the first wall 602 and the second wall 606 spaced apart from the first wall 602. The inflatable product 600 can also comprise the air chamber 638 defined by the first and second walls 602, 606. The inflatable product 600 can further comprise the plurality of tensioning beams 608 disposed in the air chamber 638 and coupled to the first and second walls 602, 606. Each of the tensioning beams 608 can comprise the first sheet 632 made of a first flexible material. The first sheet 632 can have an outer perimeter 640. The inflatable product 600 can comprise the second sheet 634 made of a second flexible material. The second sheet 634 can have an outer perimeter 642. The outer perimeter 642 of the second sheet 634 can overlap the outer perimeter 640 of the first sheet 632. The first sheet 632 may withstand a heavier load at certain elongation than the second sheet 634.

The first sheet 632 can be coupled to the second sheet 634 by any one of hot coupling, adhering, suturing, or any other desired coupling technique. At least one of the first and second sheets 632, 634 can be adapted to be coupled to the first and second walls 602, 606 by high-frequency welding or any other desired technique. The first sheet 632 may have a higher melting point than the second sheet 634.

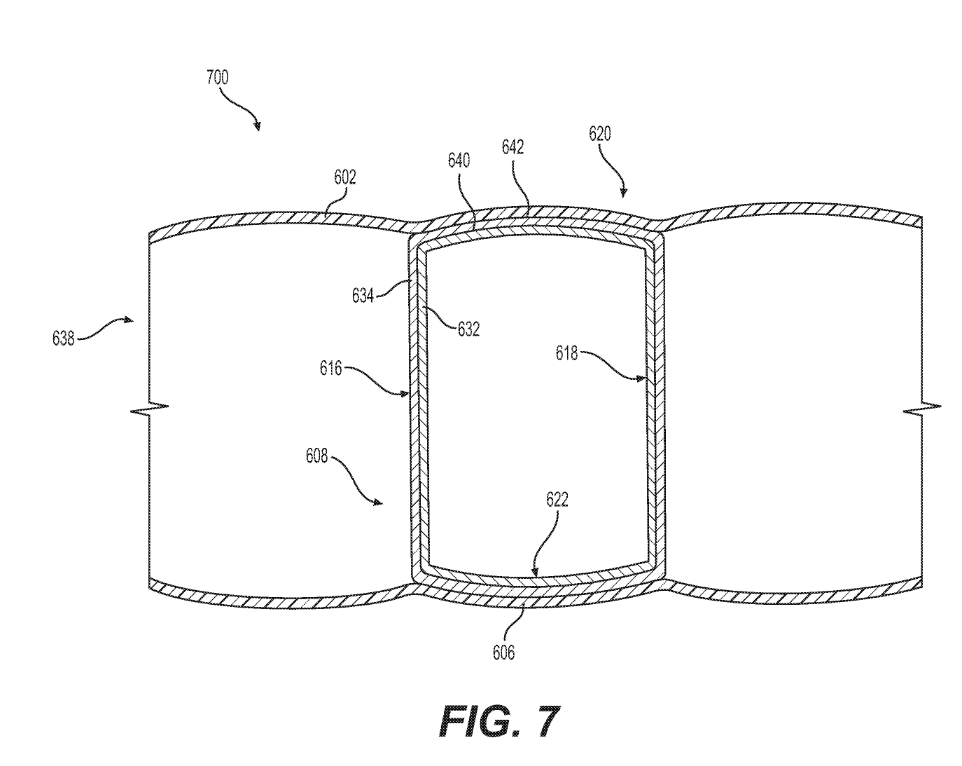

Referring back to FIGS. 4-5, the inflatable product 400 can be an inflatable spa, a pool, or any other desired inflatable product. The inflatable spa can include a first wall that is the internal wall 410 of the inflatable spa and a second wall that is the external wall 412 of the inflatable spa. The inflatable spa can further comprise the top wall 402 and the bottom wall 406. The top wall 402, the bottom wall 406, the internal wall 410, and the external wall 412 can define an air chamber, such as the air chamber 638. Each tensioning beam 408 can be I-shaped (as shown by way of example in FIGS. 1-5), coil-shaped (as shown by way of example in FIGS. 6-8), or any other desired shape. For example, as shown by way of example in FIGS. 6-7, each tensioning beam 408 can comprise a pair of substantially vertical ends 616, 618 and a pair of substantially horizontal ends 620, 622. The vertical ends 616, 618 and the horizontal ends 620, 622 can be vertical, horizontal, or arranged in any other desired direction or configuration. The pair of vertical ends 616, 618 can be respectively coupled to the internal and external walls 410, 412 via the second sheet 634 by high-frequency welding, hot coupling, or any other desired coupling technique. The internal and external walls 410, 412 can be made of the same material with same melting point as that of the second sheet 634.

Referring back to FIGS. 1-3 and 6-7, the inflatable product 100 can be an inflatable mattress or airbed, or any other desired inflatable product. The inflatable mattress can include a first wall that is the top wall 102 of the inflatable mattress, a second wall that is the bottom wall 106 of the inflatable mattress, and the lateral wall 104. The top wall 102, the bottom wall 106, and the lateral wall 104 can define an air chamber, such as air chamber 638. The tensioning beams 108 in FIGS. 1-3 are shown in an I-shaped configuration; however, as noted, the tensioning beams 108 can have alternative configurations, such as the coil-shaped configuration shown by way of example in FIGS. 6-8. Employing such a coil-shaped configuration, each of the tensioning beams 108 can comprise a pair of substantially vertical ends 616, 618 and a pair of substantially horizontal ends 620, 622. The pair of vertical ends 616, 618 can be coupled to the lateral wall 104. The pair of horizontal ends 620, 622 can be coupled to the top and bottom walls 102, 106 via the second sheet 634 by high-frequency welding, hot coupling, or any other desired coupling. The top and bottom walls 102, 106 can be made of the same material with same melting point as that of the second sheet 634. The top wall 102, the bottom wall 106, and lateral wall 104 can be made of flexible thermoplastic materials or any other desired materials.

The first sheet 632 can be made of a first material (e.g. PET or any other desired material) and the second sheet 634 can be made of a second material (e.g. PVC, PU, or any other desired material).

The first sheet 632 can be made of a first material (e.g. PVC), while the second sheet 634 can be made of a second material (e.g., PVC having different physical properties). The PVC of the first sheet 632 can withstand heavier loads at certain elongations, or stresses, than can the second sheet 634. In other words, under the same elongating force, the PVC of the first sheet 632 can make the first sheet 632 more difficult to elongate than the second sheet 634.

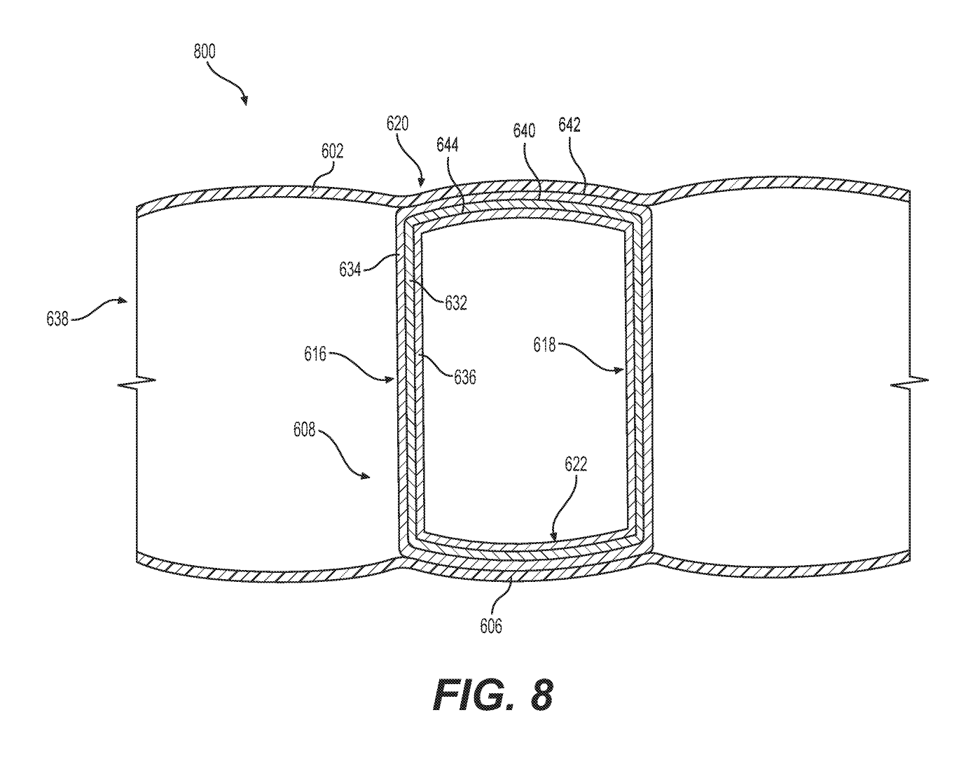

Referring to FIG. 8, the inflatable product 800 can comprise the first wall 602, the second wall 606 spaced apart from the first wall 602, and the air chamber 638 defined by the first and second walls 602, 606. The inflatable product can include a plurality of tensioning beams 608. The tensioning beams 608 can be disposed in the air chamber 638 and coupled to the first and second walls 602, 606. Each of the tensioning beams 608 can comprise the first sheet 632 made of a first flexible material and having the outer perimeter 640, a first surface, and a second surface. Each of the tensioning beams 608 can further comprise the second sheet 634 made of a second flexible material and having the outer perimeter 642. The outer perimeter 642 of the second sheet 634 can overlap the outer perimeter 640 of the first sheet 632. The second sheet 634 can be coupled to the first surface of the first sheet 632. The third sheet 636 can be made of a third material (e.g., a thermoplastic material). The third sheet 636 can have the outer perimeter 644. The outer perimeter 640 of the first sheet 632 can overlap the outer perimeter 644 of the third sheet 636. The third sheet 636 can be coupled to the second surface of the first sheet 632. The first sheet 632 may withstand a heavier load at certain elongation than the second and third sheets 634, 636.

The material of the first sheet 632 may be the same material as that of the second sheet 634. The material of the first sheet 632 may be a different material than that of the second sheet 634 and/or the third sheet 636. Thus, the first sheet 632 may have a higher melting point than that of the second and third sheets 634, 636.

The second and third sheets 634, 636 can be respectively coupled to the first sheet 632 by one of hot coupling, adhering, suturing, welding, seaming, or any other desired coupling technique. At least one of the second and third sheets 634, 636 can be adapted to be coupled to the first and second walls 602, 606 by high frequency welding or any other desired technique.

The first sheet 632 can be made of a first material (e.g. PVC), while the second and third sheets 634, 636 can be made of a second material (e.g., PVC, PU, PVC having different physical properties, or any other desired material). The PVC of the first sheet 632 can withstand heavier loads at certain elongations, or stresses, than can the second sheet 634. In other words, under the same elongating force, the PVC of the first sheet 632 can make the first sheet 632 more difficult to elongate than the second sheet 634.

For example, the first sheet 632 can be made of PVC while the second and third sheet 636 can be made of PVC having different physical properties. The PVC of the first sheet 632 can withstand heavier loads at certain elongations, or stresses, than can the second and third sheets 634, 636. In other words, under the same elongating force, the PVC of the first sheet 632 can make the first sheet 632 more difficult to elongate than the second sheet 634 and/or the third sheet 636.

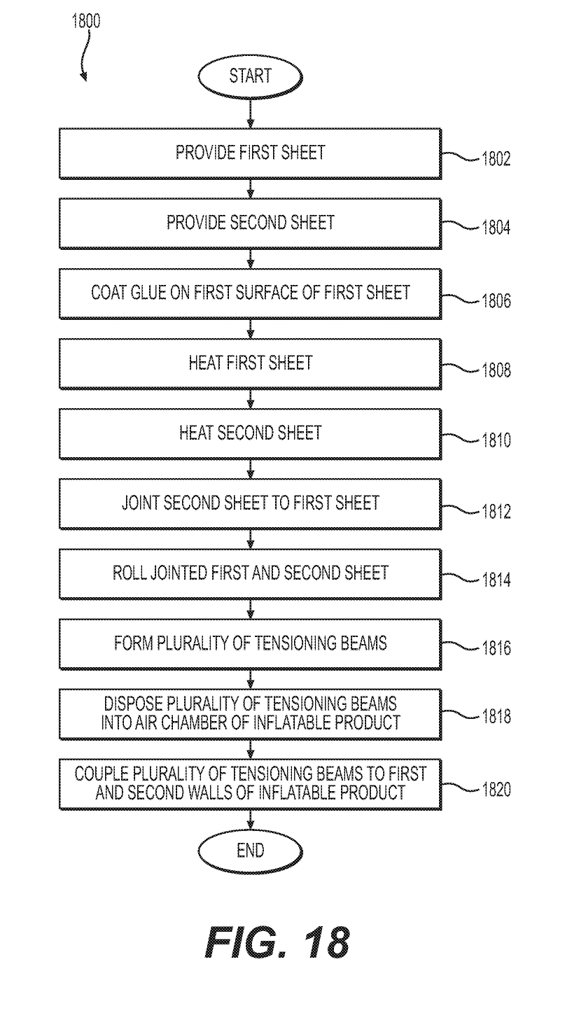

In some exemplary implementations of the disclosure, a method 1800 of manufacturing an inflatable product is disclosed. FIG. 18 illustrates the method 1800. At step 1802, a first sheet 632 is provided. At step 1804, a second sheet 634 is provided. The first sheet 632 can be made of a first material, such as a flexible material. The second sheet 634 can be made of a second material, such as a flexible thermoplastic material. The first sheet 632 may withstand a heavier load at a certain elongation than the second sheet 634. At step 1806, glue (e.g., 70 g/m2) can be coated on a first surface of the first sheet 632. At step 1808, the first sheet 632 can be heated to about 160 degrees Celsius. At step 1810, the second sheet 634 can be heated to about 180 degrees Celsius. The first and second sheets 632, 634 can be heated, for example, in one or more stoves. At step 1812, the second sheet 634 can be joined to the first sheet 632. The outer perimeter 642 of the second sheet 634 can overlap with the outer perimeter 640 of the first sheet 632. At steps 1814 and 1816, the joined first and second sheets 632, 634 can be rolled using a roller with, for example, 70 kg of pressure to form a plurality of tensioning beams 108. At step 1818, the plurality of tensioning beams 108 can be disposed into an air chamber 638 of the inflatable product 100. At step 1820, each of the plurality of tensioning beams 108 can be coupled to the first and second walls 102, 106 of the inflatable product 100 via the second sheet 634.

In some exemplary embodiments, the first sheet 632 may have a higher melting point than the second sheet 634. The first sheet 632 can be made of PET and the second sheet 634 can be made of PVC or PU.

The first sheet 632 can be made of PVC, while the second sheet 634 and third sheet 636 can be made of PVC having different physical properties. The PVC of the first sheet 632 may withstand heavier loads at certain elongations, or stresses, than the second sheet 634. In other words, under the same elongating force, the PVC of the first sheet 632 can make the first sheet 632 more difficult to elongate than the second sheet 634.

The first wall 102 can provide an internal wall of the inflatable product 100, and the second wall 106 can also provide an internal wall of the inflatable product 100. The inflatable product 100 can further comprise a top wall 102 and a bottom wall 106, both of which cooperate to define the air chamber 638. Each of the tensioning beams 108 can comprise a pair of substantially horizontal ends 620, 622, one of the horizontal ends 620 and the top wall 102 defining a first gap, and the other of the horizontal ends 622 and the bottom wall 106 defining a second gap. Each of the tensioning beams 108 can comprise a plurality of recesses 128, 130. The recesses 128,130 cooperate with the top and bottom walls 102, 106 to define the gap 124, 126.

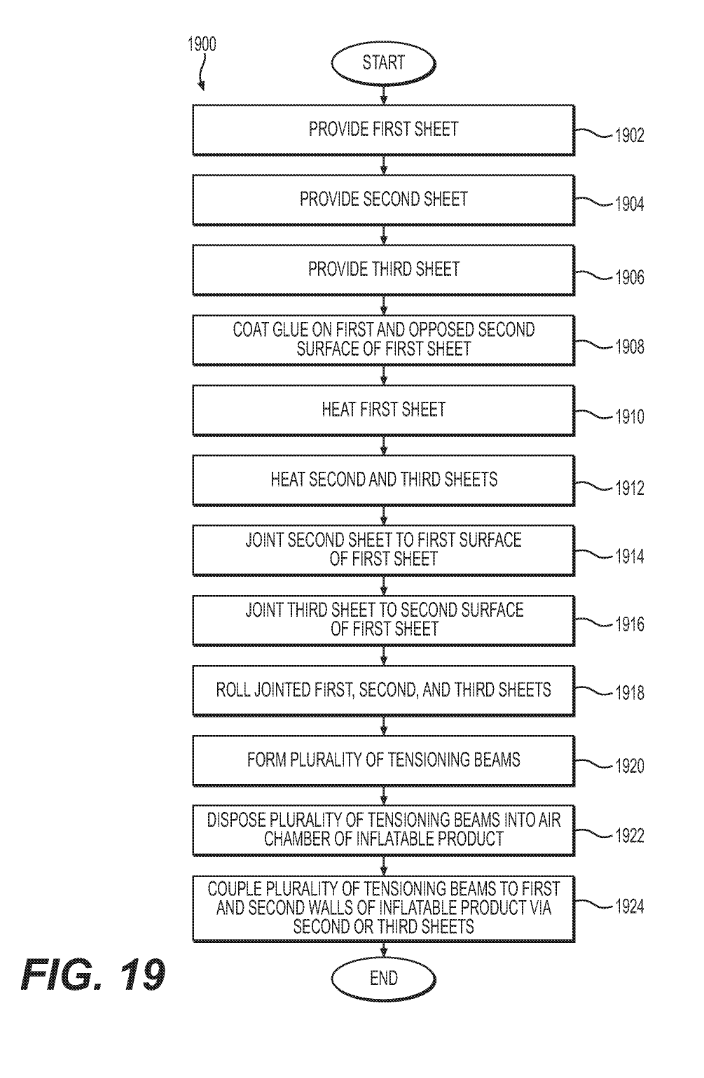

In some exemplary implements of the disclosure, a method 1900 of manufacturing an inflatable product is disclosed. FIG. 19 illustrates the method 1900. At step 1902 a first sheet 632 is provided. At step 1904, a second sheet 634 is provided. At step 1806, the third sheet 636 is provided. The first sheet 632 can be made of a first material, such as a flexible material or any other desired material. The second and third sheets 634, 636 can be made of a second material, such as a flexible thermoplastic material or any other desired material. The first sheet 632 may withstand a heavier load at a certain elongation than the second and third sheets 634, 636. At step 1908, glue (e.g., 70 g/m2) can be coated on a first surface and an opposed second surface of the first sheet 632. At step 1910, the method includes heating to about 160 degrees Celsius to heat the first sheet 632. At step 1912, the method can include heating the second and third sheets 634, 636 to about 180 degrees Celsius. At step 1914, the second sheet 634 can be joined to the first surface of the first sheet 632. At step 1916, the third sheet 636 can be joined to the second surface of the first sheet 632. The outer perimeter 642 of the second sheet 634 and the outer perimeter 644 of the third sheet 636 can overlap with the outer perimeter 640 of the first sheet 632. At steps 1918 and 1920, the joined first, second, and third sheets 632, 634, 636 can be rolled using a roller with, for example, 70 kg of pressure to form a plurality of tensioning beams 108. At step 1922, the plurality of tensioning beams 108 can be disposed into an air chamber 638 of the inflatable product 100. At step 1924, each of the tensioning beams 108 can be coupled to the first and second walls 102, 106 of the inflatable product 100 via one of the second and third sheets 634, 636.

In some exemplary embodiments, the first sheet 632 may have a higher melting point than the second and third sheets 634, 636. The material of the second sheet 634 can be the same as that of the third sheet 636. The first sheet 632 can be made of PET, and the second and third sheets 634, 636 can be made of PVC, PU, or any other desired material. The material of the second and third sheets 634, 636 can also be different materials.

The first sheet 632 can be made of PVC, while the second and third sheets 634, 636 can be made of PVC having different physical properties. The PVC of the first sheet 632 may withstand heavier loads at certain elongations, or stresses, than can the second and third sheets 634, 636. In other words, under the same elongating force, the PVC of the first sheet 632 can make the first sheet 632 more difficult to elongate than the second sheet 634 and/or the third sheet 636.

The methods 1800, 1900 can include additional and/or fewer steps and are not limited to those illustrated in FIGS. 18 and 19. The methods 1800, 1900 may be used for manufacturing inflatable product 100, inflatable product 400, or any other desired inflatable product.

While the tensioning structures and inflatable products using the tensioning structures disclosed herein may be implemented in many different forms, the disclosure shows in the drawings and describes herein implementations with the understanding that the present description is to be considered as merely exemplary of the principles of the tensioning structures and inflatable products using the tensioning structures, and is not intended to limit the broad aspects of the disclosure to the implementations illustrated. Accordingly, the drawings and description are to be regarded as illustrative in nature and not restrictive.

The present disclosure seeks to overcome some limitations and other drawbacks of the prior art, and to provide new features not heretofore available. The tensioning structures and inflatable products using the tensioning structures according to the present disclosure have achieved improved functionality and flexibility.

In some implementations, the disclosure provides an inflatable product including a first wall, a second wall spaced apart from the first wall, an air chamber defined by the first and second walls and a plurality of tensioning beams disposed in the air chamber and coupled to the first and second walls. Each of the tensioning beams can include an anti-elongation layer. Further, the inflatable product can include third, fourth, fifth and sixth walls, and each of the first through sixth walls can be any of a left wall, a right wall, a front wall, a rear wall, an upper wall and/or a lower wall. Further, the tensioning beams can connect any two or more of the first-six walls and/or a left wall, a right wall, a front wall, a rear wall, an upper wall and a lower wall.

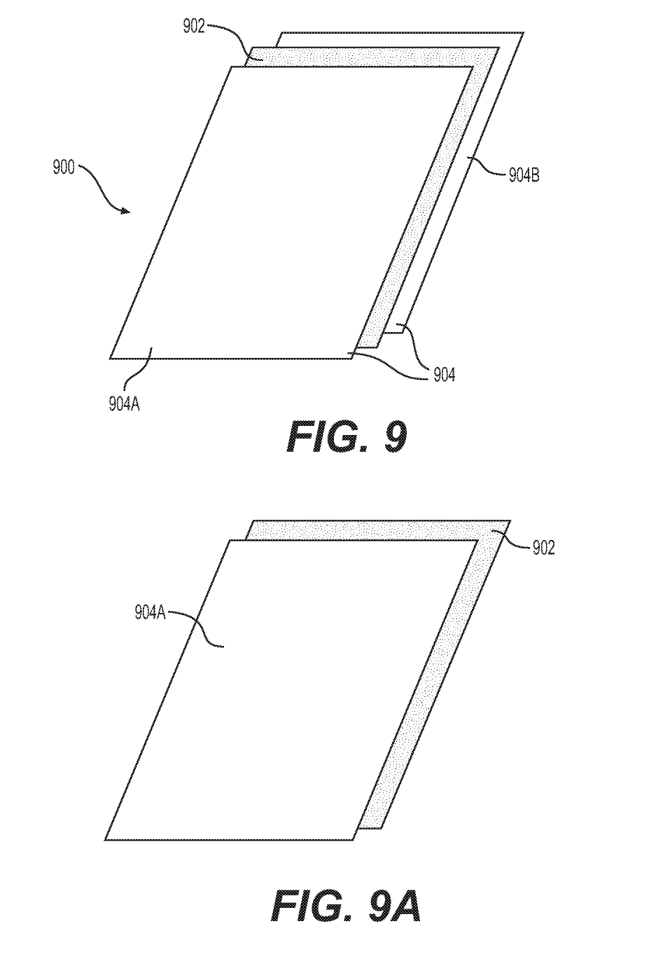

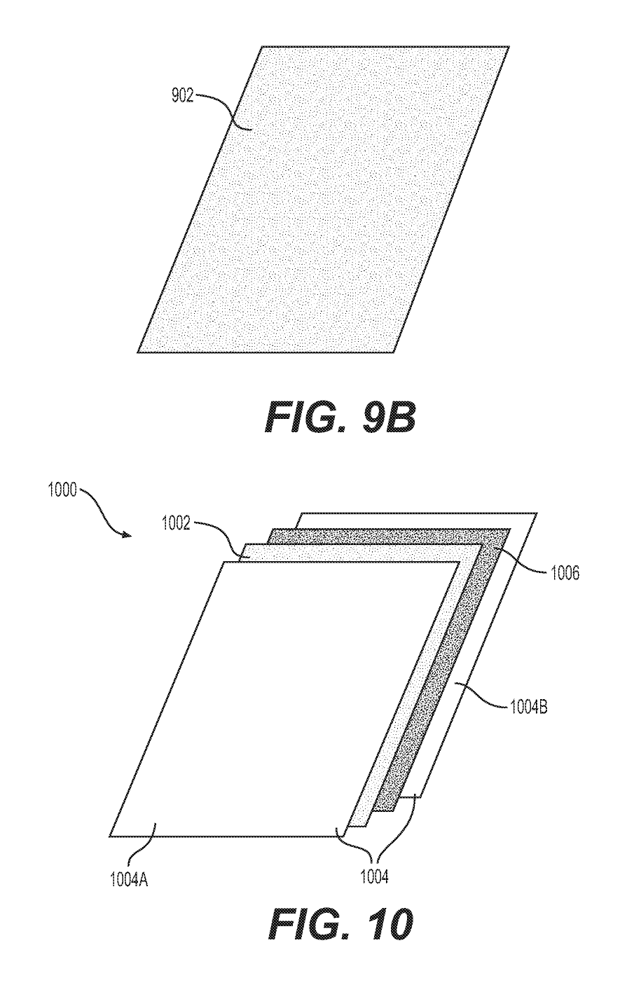

Referring now to the FIGS. 9-17A, tensioning beams are illustrated that include an anti-elongation layer and at least one flexible layer.

FIG. 9 illustrates a tensioning beam 900 including an anti-elongation layer 902 laminated between a pair of flexible layers 904. The pair of flexible layers 904 can include a flexible layer 904A and a flexible layer 904B. The pair of flexible layers 904 can include or be made of PVC layers. FIG. 9A illustrates the tensioning beam 900 including the anti-elongation layer 902 laminated with the flexible layer 904A, such as a PVC layer according to exemplary implementations of the present disclosure. FIG. 9B shows the anti-elongation layer 902 of the tensioning beams 900 of FIGS. 9 and 9A.

The tensioning beam 900 can include an anti-elongation layer 902 and a pair of flexible layers 904 including a thermal plastic material. The anti-elongation layer 902 can be laminated between the pair of flexible layers 904, and can further include, or be made of, suitable materials exhibiting sufficient tensile strength and resistance to elongation to withstand loads, such as loads induced upon inflation of the inflatable product 100 or any other desired product. The pair of flexible layers 904 can include, or be made of, thermal plastic materials such as PVC, which have similar properties, such as melting point, to facilitate coupling to the walls of the inflatable product 100 or any other desired product. The laminating can be performed, or realized, through high-frequency welding, hot coupling, adhesion (e.g. gluing), seaming, and/or any other suitable technique.

In some implementations, the anti-elongation layer 902 includes PVC having a higher melting point than does the flexible layer 904, whether one or more flexible layers are used. Alternatively, the anti-elongation layer 902 can include polyethylene terephthalate (PET), polypropylene (PP), acrylonitrile butadiene styrene (ABS), and/or any other desired material. In some implementations, the anti-elongation layer 902 can include a composite material comprising a matrix of PVC and ABS. The composite material can have a melting point higher than that of the flexible layer 904. In some implementations, the anti-elongation layer 902 can include non-woven fabric. The non-woven fabric can include micro pores allowing melting materials to pass therethrough to enhance coupling.

In some implementations, as shown in FIG. 9A, the tensioning beam 900 can include an anti-elongation layer 902 and a flexible layer 904A including, or made of, a thermal plastic material. The flexible layer 904A can be laminated on either side of the anti-elongation layer 902. The flexible layer 904A can include, or be made of, PVC and can include first and second edges or portions for coupling to the first and second walls, respectively, and/or any other walls of the inflatable product. The anti-elongation layer 902 is shown in isolation in FIG. 9B.

FIG. 10 illustrates a tensioning beam 1000 including a reinforcing layer 1006, a pair of flexible layers 1004 (including flexible layers 1004A, B), and an anti-elongation layer 1002 according to exemplary implementations of the present disclosure. In some implementations, as illustratively shown in FIG. 10, the anti-elongation layer 1002 can include at least one reinforcing layer 1006 laminated thereon. The lamination of the reinforcing layer 1006 with the anti-elongation layer 1002 can be realized through welding, hot coupling, adhesion (e.g. gluing), seaming, or any other suitable technique.

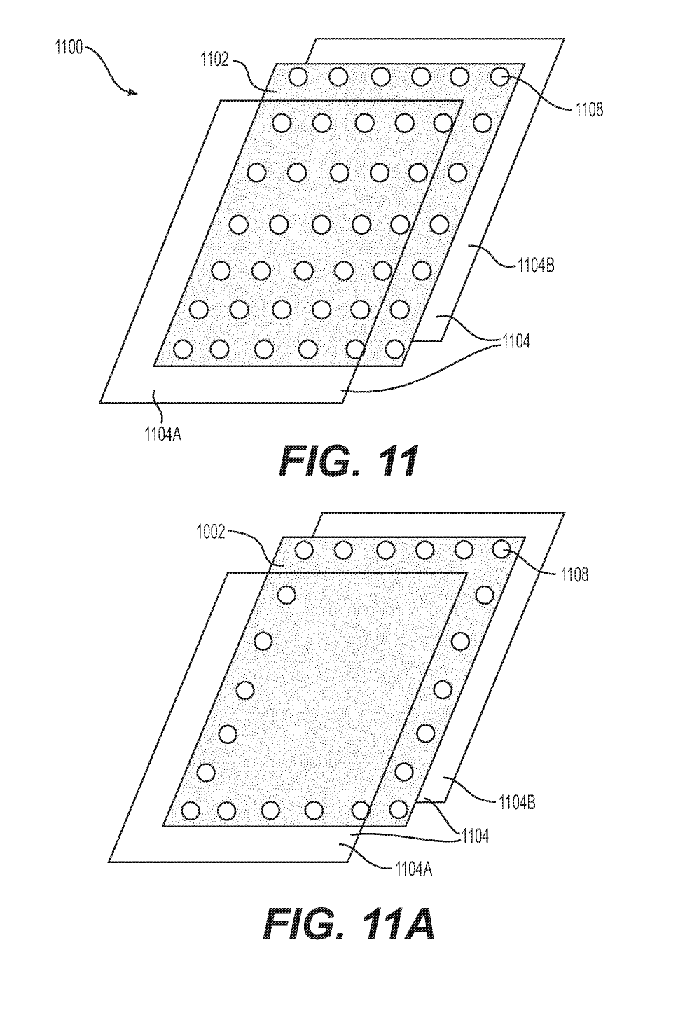

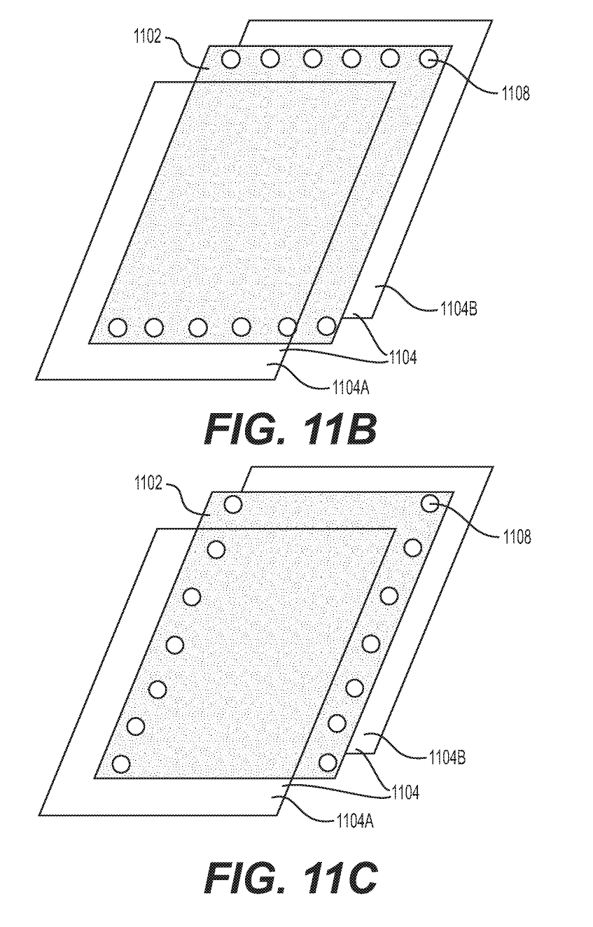

FIGS. 11, 11A, 11B, and 11C illustrate tensioning beams 1100 including a pair of flexible layers 1104 (including flexible layers 1104A, B) and an anti-elongation layer 1102 including a plurality of holes 1108 according to exemplary implementations of the present disclosure. In some implementations, the anti-elongation layer 1102 can include a plurality of holes 1108 to facilitate laminating with the flexible layers 1104, as exemplarily shown in FIG. 11. Such laminating can be implemented by high-frequency welding, hot coupling, adhesion (e.g. gluing), or any other suitable technique. In some implementations, the anti-elongation layer 1102 can include an outer perimeter, and the plurality of holes 1108 can be disposed at, near, and/or proximate to the outer perimeter. Such an arrangement is exemplarily shown in FIG. 11A. In some implementations, the holes 1108 can be disposed at, near, and/or proximate horizontal edges or portions of the anti-elongation layer 1102 adjacent the first and second walls, as exemplarily shown in FIG. 11B. In some implementations, the holes 1108 can be disposed at, near, and/or proximate vertical edges or portions of the anti-elongation layer 1102, as exemplarily shown in FIG. 11C.

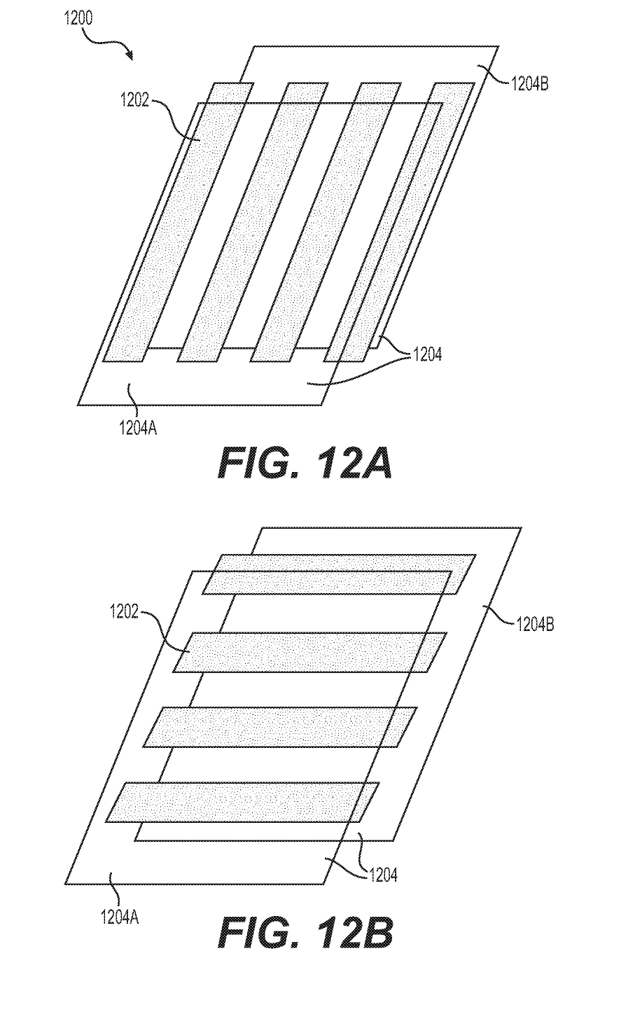

FIGS. 12A and 12B illustrate a tensioning beam 1200 including a pair of flexible layers 1204 (including flexible layers 1204A, B) and an anti-elongation layer 1202 defined by a plurality of strips arranged in an array according to exemplary implementations of the present disclosure. In some implementations, the tensioning beam 1200 can include a pair of flexible layers 1204 made of a thermal plastic material, and can further include a plurality of anti-elongation strips 1202. The anti-elongation strips 1202 can be laminated between the pair of flexible layers 1204 in an array spaced apart from each other. In particular, the anti-elongation strips 1202 can be disposed in parallel, or substantially in parallel, to each other along a vertical direction of the flexible layer 1204, as exemplarily shown in FIG. 12A. Alternatively, the anti-elongation strips 1202 can be disposed in parallel, or substantially in parallel, to each other along a horizontal direction of the flexible layer 1204, as exemplarily shown in FIG. 12B.

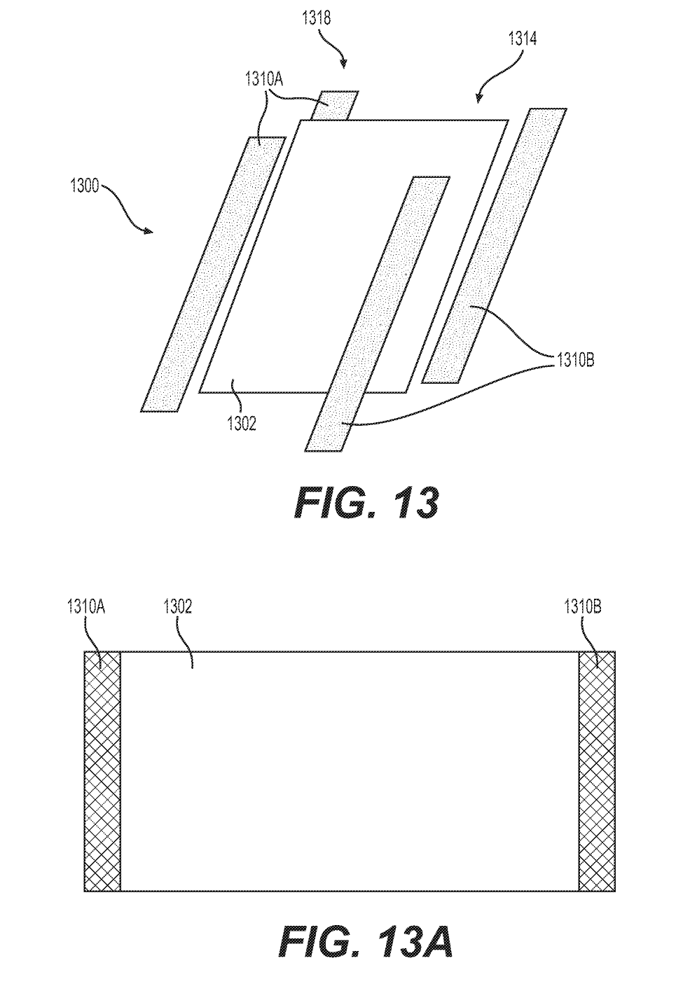

In some implementations, the tensioning beam can further include a coupling structure for coupling the anti-elongation layer and/or the laminated multi-layer to the walls of the inflatable product 100. FIGS. 13 and 13A illustrate a tensioning beam 1300 including a coupling structure 1314, and further illustrate first and second pairs of coupling layers 1310A, B according to exemplary implementations of the present disclosure.

In some implementations and as exemplarily shown in FIGS. 13 and 13A, the coupling structure 1314 can include a first pair of coupling layers 1310A (e.g. welding layers) and a second pair of coupling layers 1310B (e.g. welding layers). The anti-elongation layer 1302 (or a laminated multi-layer) can define a first edge which can be adjacent the first wall and a second edge which can be adjacent the second wall. A sandwiching arrangement 1318 may be formed when the first edge of the anti-elongation layer 1302 (or the laminated multi-layer) is sandwiched by the first pair of coupling layers 1310A, and the second edge of the anti-elongation layer 1302 (or the laminated multi-layer) is sandwiched by the second pair of coupling layers 1310B. The first and second pair of coupling layers 1310A, B can include flexible thermal plastic materials such as PVC, mesh, and/or any other suitable materials to facilitate the coupling of the tensioning structure to the first and second walls, or any other walls of the inflatable product, respectively.

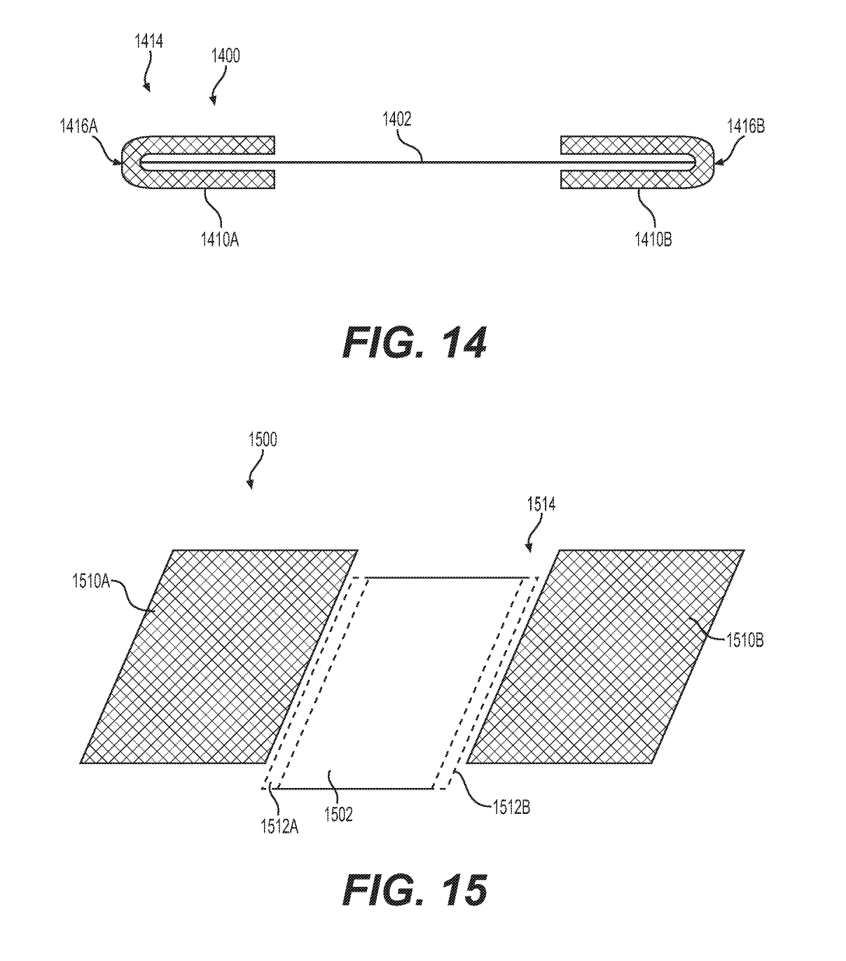

FIG. 14 illustrates a tensioning beam 1400 having a coupling structure 1414 including first and second folded coupling layers 1410 according to exemplary implementations of the present disclosure. In some implementations, as exemplarily shown in FIG. 14, the coupling structure 1414 can include a first coupling layer 1410A (e.g. welding layer) and a second coupling layer 1410B (e.g. welding layer). The first coupling layer 1410A can be folded about an end 1416A of the anti-elongation layer 1402 (or the laminated multi-layer) adjacent the first wall, and the second coupling layer 1410B can be folded about an opposite end 1416B of the anti-elongation layer 1402 (or the laminated multi-layer) adjacent the second wall. The first and second coupling layers 1410A, B can include flexible thermal plastic materials such as PVC, mesh, and/or any other suitable materials to facilitate coupling with the first and second walls, respectively.

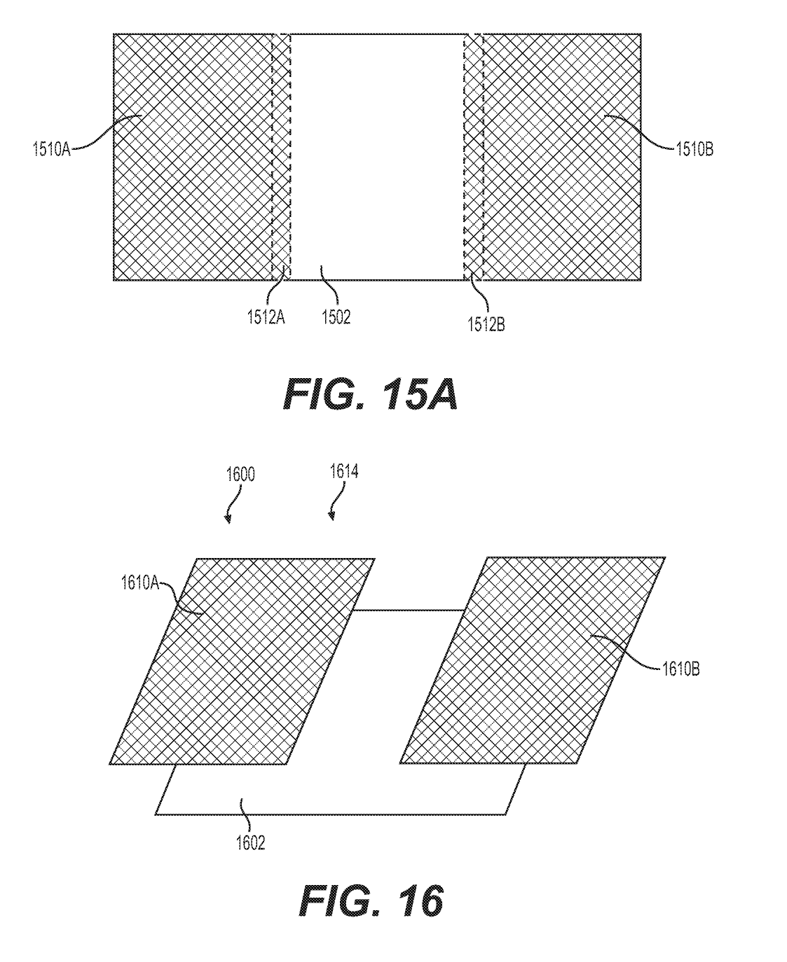

FIGS. 15 and 15A illustrate a tensioning beam 1500 having a coupling structure 1514 including first and second coupling layers 1510A, B for coupling multiple edges 1512A, B, respectively, of an anti-elongation layer 1502 (or of a laminated multi-layer material) according to exemplary implementations of the present disclosure. In some implementations, as exemplarily shown in FIGS. 15 and 15A, the coupling structure 1514 can include a first coupling layer 1510A (e.g. welding layer) and a second coupling layer 1510B (e.g. welding layer). The anti-elongation layer (or the laminated multi-layer) can define a first edge 1512A and a second edge 1512B for coupling with the first and second coupling layers 1510A, B, respectively. The coupling can be realized through high frequency welding, hot coupling, adhesion (e.g., gluing), seaming, and/or any other suitable technique.

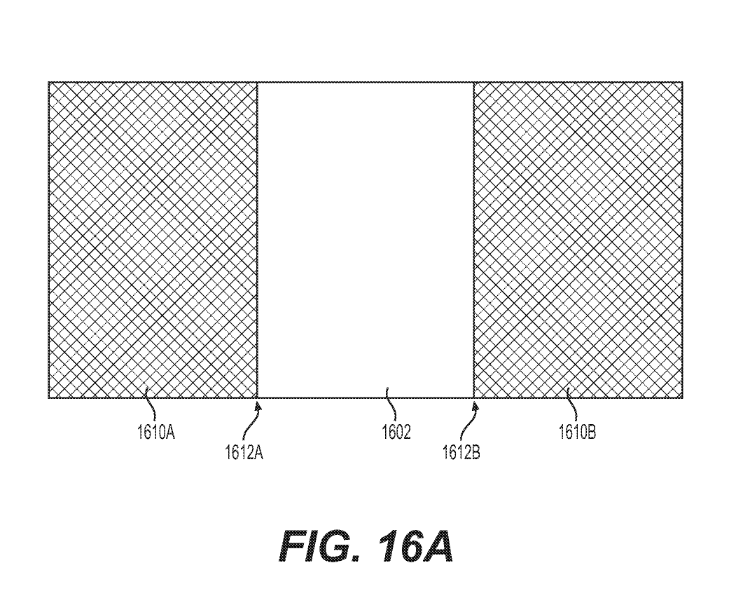

FIGS. 16 and 16A illustrate a tensioning beam 1600 having a coupling structure 1614 including first and second coupling layers 1610A, B for laminating an anti-elongation layer 1602 (or the laminated multi-layer material) according to exemplary implementations of the present disclosure. In some implementations, as exemplarily shown in FIGS. 16 and 16A, the coupling structure 1614 includes a first coupling layer 1610A (e.g. welding layer) and a second coupling layer 1610B (e.g. welding layer). The anti-elongation layer 1602 (or the laminated multi-layer) can include a first portion 1612A and a second portion 1612B for laminating the first and second coupling layers 1610A, B, respectively. The laminating can be realized through high frequency welding, hot coupling, adhesion (e.g., gluing), seaming, and/or any other suitable technique.

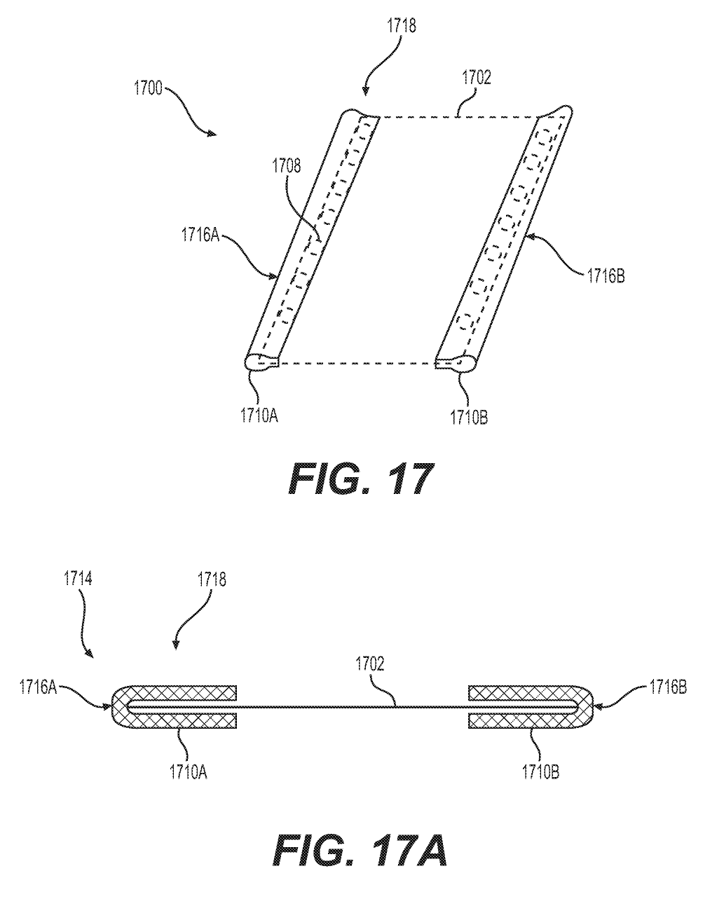

FIGS. 17 and 17A illustrate a tensioning beam 1700 having a multi-layer material 1702 defining a plurality of holes 1708 and a coupling structure 1714 including first and second folded coupling layers 1710A, B, according to exemplary implementations of the present disclosure. In some implementations, as exemplarily shown in FIGS. 17 and 17A, the coupling structure 1714 includes a first folded coupling layer 1710A (e.g. welding layer) and a second folded coupling layer 1710B (e.g. welding layer) each forming a sandwiching arrangement 1718. The laminated multi-layer 1702 (or the anti-elongation layer) can define a first edge 1716A and a second edge 1716B sandwiched by the first and second folded coupling layers 1710A, B, respectively. The edges 1716A, B can be another portion of the laminated multi-layer 1702 (or the anti-elongation layer). The first and second folded coupling layers 1710A, B can have a C-shaped cross-section when sandwiching the first and second edges 1716A, B of the anti-elongation layer and/or the laminated multi-layer 1702. The sandwiched arrangement 1718 can be realized through high frequency welding, hot coupling, adhesion (e.g., gluing), seaming and/or any other suitable technique. In an exemplary implementation, a plurality of holes 1708 is defined along first and second edges 1716A, B of the anti-elongation layer and/or the laminated multi-layer 1702. The holes 1708 can facilitate the sandwiching arrangement 1718, as well as the coupling between the tensioning beam 1700 and walls of the inflatable product 100.

Any of the above-described elements can include a flexible thermoplastic material or a rigid material, and further elements can be connected by one or more of high frequency welding, adhesion and any other attachment technique known to those skilled in the art. Additionally, it is to be understood that all described elements and features in this disclosure can be formed of any number of materials including, but not limited to, polymers, plastics, rubbers, foams, vinyl, PVC, coated fabric, metals, metal alloys or any other suitable material known to those skilled in the art. The inflatable product formed can include an airbed, air mattress, inflatable spa, inflatable pool, or any other desired inflatable product.

While some implementations have been illustrated and described, numerous modifications may come to mind without significantly departing from the spirit of the disclosure, and the scope of protection is only limited by the scope of the accompanying claims.

Headings and subheadings, if any, are used for convenience only and do not limit the invention. The word exemplary is used to mean serving as an example or illustration. To the extent that the term include, have, or the like is used, such terms are intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The disclosed systems and methods are well adapted to attain the ends and advantages mentioned as well as those that are inherent therein. The particular implementations disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative implementations disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately ab”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A tensioning beam for an inflatable product, comprising:
a first layer;
a first and a second pair of coupling layers; and
a sandwiching arrangement, wherein a first portion of the first layer is sandwiched between the first pair of coupling layers and a second portion of the first layer is sandwiched between the second pair of coupling layers.

2. The tensioning beam of claim 1, wherein the first layer is an anti-elongation layer or a laminated multi-layer.

3. The tensioning beam of claim 1, wherein the first and second pairs of coupling layers include a flexible thermal plastic material to facilitate coupling of the tensioning beam to first and second walls of the inflatable product.

4. The tensioning beam of claim 3, wherein the first pair of coupling layers is folded about an end of the first layer adjacent the first wall and the second pair of coupling layers is folded about an opposite end of the first layer adjacent the second wall.

5. The tensioning beam of claim 3, wherein a plurality of holes are included in the first and second portions of the first layer to facilitate the sandwiching arrangement and coupling between the tensioning beam and the first and second walls of the inflatable product.

6. The tensioning beam of claim 1, further including a coupling structure, and wherein the first and second pairs of coupling layers are folded about the coupling structure and in contact with at least two sides of the coupling structure.

7. The tensioning beam of claim 1, wherein the first portion and the second portion are coupled between the first and second pairs of coupling layers using high frequency welding, hot coupling, adhering, suturing, or seaming.

8. The tensioning beam of claim 1, wherein the first and second pairs of coupling layers include a C-shaped cross-section when sandwiching the first and second portions of the first layer.

9. The tensioning beam of claim 1, wherein the first layer includes a plurality of strips arranged in an array.

10. An inflatable product, comprising:
a first wall;
a second wall spaced apart from the first wall;
an air chamber defined by at least the first and second walls; and
a plurality of tensioning beams disposed in the air chamber and coupled to the first and second walls, each of the plurality of tensioning beams comprising:
a first sheet made of a first flexible material and having an outer perimeter; and
a second sheet made of a second flexible material and having an outer perimeter, the outer perimeter of the second sheet overlapping the outer perimeter of the first sheet; and
wherein the first sheet withstands a heavier load resulting from elongation than the second sheet.

11. The inflatable product of claim 10, wherein the first sheet is coupled to the second sheet by one of welding, hot coupling, adhering, suturing, and seaming.

12. The inflatable product of claim 10, wherein at least one of the first and second sheets is coupled to the first and second walls.

13. The inflatable product of claim 10, wherein the first sheet has a higher melting point than the second sheet.

14. The inflatable product of claim 10, wherein the inflatable product is an inflatable pool, wherein the first wall is an internal wall of the inflatable pool, the second wall is an external wall of the inflatable pool, and the inflatable pool further comprises a top wall and a bottom wall, wherein the top wall, the bottom wall, the internal wall, and the external wall define the air chamber;
wherein each of the tensioning beams comprises a pair of substantially vertical first ends and a pair of substantially horizontal second ends, wherein the pair of the first ends is respectively coupled to the internal and external walls via the second sheet, and the internal and external walls are made of the same material as that for the second sheet, one of the second ends and the top wall defining a top gap, and the other of the second ends and the bottom wall defining a bottom gap; and
wherein the bottom wall and the internal wall define a container for receiving fluid, and the top and bottom walls, the internal and external walls, and the second sheet are made of a flexible thermoplastic material.

15. The inflatable product of claim 14, wherein each tensioning beam includes a plurality of recesses, the plurality of recesses cooperating with the top and bottom walls to define the top and bottom gaps.

16. The inflatable product of claim 10, wherein the inflatable product is an inflatable mattress, wherein the first wall is a top wall of the inflatable mattress, the second wall is a bottom wall of the inflatable mattress, and the inflatable mattress further comprises a lateral wall, wherein the top wall, the bottom wall, and the lateral wall define the air chamber; and
wherein each of the tensioning beams comprises a pair of substantially vertical first ends and a pair of substantially horizontal second ends, wherein the pair of the first ends and the lateral wall define a gap, the pair of second ends is respectively coupled to the top and bottom walls via the second sheet, and the top and bottom walls are made of the same material as that for the second sheet; and the top wall, the bottom wall, and the lateral wall are made of flexible thermoplastic material.

17. The inflatable product of claim 16, wherein each tensioning beam includes a plurality of recesses, the plurality of recesses cooperating with the lateral wall to define the gap.

18. An inflatable product, comprising:
a first wall;
a second wall spaced apart from the first wall;
an air chamber defined by at least the first and second walls; and
a plurality of tensioning beams disposed in the air chamber and coupled to the first and second walls, each of the plurality of tensioning beams comprising:
a first sheet made of a first flexible material and having an outer perimeter, the first sheet having a first surface and a second surface;
a second sheet made of a second flexible material and having an outer perimeter, the outer perimeter of the second sheet overlapping the outer perimeter of the first sheet, and the second sheet being coupled to the first surface of the first sheet; and
a third sheet made of a thermoplastic material and having an outer perimeter, the outer perimeter of the third sheet overlapping the outer perimeter of the first sheet, and the third sheet being coupled to the second surface of the first sheet; and
wherein the first sheet withstands a heavier load resulting from elongation than the second and third sheets.

19. The inflatable product of claim 18, wherein the first flexible material is the same material as the second flexible material.

20. The inflatable product of claim 18, wherein the first flexible material is a different material than that of the second and third flexible materials.
